(19) United States
(12) Patent Application Publication
(10) Pub. No.: US 2026/0047585 A1
(43) Pub. Date: Feb. 19, 2026

(54) MULTIUSE REUSABLE POPSICLE STICK

(71) Applicants: Yaacov Jackie CABABIA, Ganie Tikva (IL); Eli GERASI, Ganie Tikva (IL)

(72) Inventor: Eli GERASI, Ganie Tikva (IL)

(73) Assignees: Yaacov Jackie CABABIA, Ganie Tikva (IL); Eli GERASI, Ganie Tikva (IL)

(21) Appl. No.: 19/369,237

(22) Filed: Oct. 26, 2025

Related U.S. Application Data
(63) Continuation-in-part of application No. PCT/IL2024/050517, filed on May 26, 2024.
(60) Provisional application No. 63/469,567, filed on May 30, 2023.

(51) Int. Cl. A23G 9/50; A63H 3/16; A63H 17/00; A63H 27/00; A63H 33/22; F21V 23/00; F21Y 115/10

(52) U.S. Cl. CPC A23G 9/503; A63H 33/22; F21V 23/003; A63H 3/16; A63H 17/002; A63H 27/001; F21Y 2115/10

(57) ABSTRACT

A multiuse stick, which may be used as a popsicle stick and reused for lighting and/or entertainment, e.g., as a toy and/or component thereof. The multiuse stick may be made of light conducting material and/or include a light guide. Light may be supplied by a LED and/or batteries. The LED and/or batteries may be internal or external to the popsicle stick. The multiuse stick may be configured for use as a toy and/or part thereof. The multiuse stick may be configured for use as a light and/or a wearable ornament. The multiuse stick may be used in the manufacture homemade popsicles and/or commercially produced popsicles. Components of the system may be sold separately and/or together, e.g., as a kit, as a unit, etc.

### RELATED APPLICATION/S

This application is a Continuation in Part of International patent application PCT/IL2024/050517 filed on 26 May 2024 which claims the benefit of priority under 35 USC § 119(e) of U.S. Provisional Patent Application No. 63/469,567 filed on 30 May 2023, the contents of which are incorporated herein by reference in their entirety.

### FIELD AND BACKGROUND OF THE INVENTION

The present invention, in some embodiments thereof, relates to a multiuse stick and, more particularly, but not exclusively, for lighting and/or entertainment.

Popsicles or popsicles are one of the oldest desserts, with commercial production beginning in the early 1850s. The popsicles market was valued at USD 62.8 billion in 2021 and is expected to reach the value of USD 107.50 billion by 2029, at a CAGR of 6.95% during the forecast period of 2022-2029.

The global popsicles market is expected to experience growth in the coming years, driven by several factors, such as consumers increasingly seek healthier options, such as low-sugar, minimally processed, non-dairy desserts, Keto-friendly treats, and fruit bars for various dietary goals (snacks, protein, energy), transparently labelled desserts. This trend benefits the popsicles market as manufacturers create products that cater to these preferences.

Most commercial popsicles have sticks made from wood. While wood is an abundant and relatively inexpensive material, making it an economical choice for producing large quantities of ice cream sticks, the environmental benefits of wooden sticks compared to plastic ones are not clear-cut. Factors like use of virgin resources for production and post-consumer disposal are concerns.

Therefore, there is a need to increase post-use usefulness while selectively increasing sales of such multiuse ice-cream sticks.

### SUMMARY OF THE INVENTION

According to an aspect of some embodiments of the invention, there is provided a method of use of a reusable popsicle stick, the method including: preparing a popsicle including a reusable popsicle stick including at least one of a connector and a built in light source; and reusing the popsicle stick including at least one of connecting the connector to another popsicle stick, connecting the connector to an external light source, connecting the connector the connector to decoration, wearing the reusable popsicle stick and activating the built in light source.

According to some embodiments of the invention, the reusable popsicle stick is reused as a party favor.

According to some embodiments of the invention, the reusable popsicle stick is reused as a light source.

According to some embodiments of the invention, the reusable popsicle stick is reused as a toy, or part thereof.

According to some embodiments of the invention, the reusable popsicle stick includes multiple connectors configured for reuse of the reusable popsicle stick.

According to some embodiments of the invention, the reusable popsicle stick includes the connector and the connector include at least one of a hole, a slit, a protrusion and a flexible connector.

According to some embodiments of the invention, the connectors are configured to facilitate interlinking between two or more reusable popsicle sticks.

According to some embodiments of the invention, at least one additional component facilitates reuse of the reusable popsicle stick.

According to some embodiments of the invention, the light source facilitates reuse of the reusable popsicle stick.

According to some embodiments of the invention, the light source is external to the reusable popsicle stick.

According to some embodiments of the invention, the method includes the external light source.

According to an aspect of some embodiments of the invention, there is provided a reusable popsicle stick including: a reusable light guide stick; and a light emitting unit.

According to some embodiments of the invention, the reusable light guide stick includes the light emitting unit internally.

According to some embodiments of the invention, the reusable light guide stick is connected to the light emitting unit externally.

According to some embodiments of the invention, the light guide stick is composed of a light conducting material.

According to some embodiments of the invention, the light conducting material is selected from the group including acrylic (polymethylmethacrylates), butyrate (cellulose acetate butyrate), polyvinyl chloride, polycarbonate, polyethylene terephthalate, glycol modified polyethylene terephthalate, polytetrafluoroethylene, polystyrene, polypropylene, polyamide, or a combination thereof.

According to some embodiments of the invention, the light conducting material includes one or more light-transmitting additives.

According to some embodiments of the invention, the stick is at least in part, transparent, semi-transparent, or translucent.

According to some embodiments of the invention, the stick is colorless.

According to some embodiments of the invention, the stick is colored.

According to some embodiments of the invention, the stick includes multiple connectors configured for reuse of the reusable popsicle stick.

According to some embodiments of the invention, the connectors are holes, slits, protrusions, or flexible connectors.

According to some embodiments of the invention, the connectors are configured to facilitate interlinking between two or more reusable popsicle sticks.

According to some embodiments of the invention, the stick further includes connection to at least one additional component which facilitates reuse of the reusable popsicle stick.

According to some embodiments of the invention, the stick further includes connection to at least one additional connector which facilitates reuse of the reusable popsicle stick.

According to some embodiments of the invention, the light emitting unit includes one or more LEDs, a controller and a battery, for empowering the controller and the LEDS via the controller.

According to some embodiments of the invention, the light emitting unit further includes a user interface.

According to some embodiments of the invention, the controller is configured for operating the light emitting unit in one or more operating modes.

According to some embodiments of the invention, each LED has a wavelength ranging between about 100 nm to about 700 nm.

According to some embodiments of the invention, the light emitting unit is configured to be activated before, during, or after consumption of the popsicle.

According to some embodiments of the invention, the light emitting unit is configured to make the popsicle and/or the stick glow.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1: A block diagram of a multiuse stick, in accordance with some embodiments.

FIG. 2: An exemplary image of a stick as a light guide with external light source with a homemade popsicle made in a plastic mold, in accordance with some embodiments.

FIGS. 3A-B: Exemplary images of a stick as a light guide with an internal light source in a homemade popsicle made in a plastic mold, in accordance with some embodiments.

FIGS. 4A-D: Various views and an exploded view of a glowing popsicle with an external light source and a light guide popsicle stick, in accordance with some embodiments.

FIG. 5: A schematic image of use of the popsicle stick as a party favor, in accordance with some embodiments.

FIGS. 6A-C: Schematic images of various ways of using sticks as a construction toy, in accordance with some embodiments.

FIGS. 7A-C: Schematic images of an exemplary toy constructed from a stick, in accordance with some embodiments.

FIGS. 8A-E: Schematic images of an exemplary toy constructed from a stick, in accordance with some embodiments.

FIGS. 9A-D: Schematic images of an exemplary toy constructed from a stick, in accordance with some embodiments.

FIGS. 10A-F: Schematic images of an exemplary toy constructed from sticks, in accordance with some embodiments.

FIGS. 11A-B: Schematic images of an exemplary toy constructed from a stick, in accordance with some embodiments.

FIG. 12: Flow chart for use of a stick as a party favor, in accordance with an embodiment of the current invention.

FIG. 13: Flow chart for use of a stick as a toy, in accordance with an embodiment of the current invention.

FIG. 14: Block diagram of a light guide stick, in accordance with an embodiment of the current invention.

FIG. 15: Block diagram of a light guide stick, in accordance with an embodiment of the current invention.

FIGS. 16A and 16B illustrate a multiuse stick with a toothed track projecting from a wide face thereof in accordance with an embodiment of the current invention.

FIG. 17 is an illustration of a multiuse stick with a connector projecting from opposite wide faces thereof in accordance with an embodiment of the current invention.

FIG. 18 is an illustration of a multiuse stick with a connector projecting from a wide face thereof in accordance with an embodiment of the current invention.

FIG. 19 is an illustration of a multiuse stick with toothed tracks projecting from opposite thin sides thereof in accordance with an embodiment of the current invention.

FIG. 20A is an illustration of a multiuse stick with a toothed track projecting from a thin side thereof and a matching connector in accordance with an embodiment of the current invention.

FIG. 20B is a close-up illustration of a connector in accordance with an embodiment of the current invention.

FIG. 20C is a close-up illustration of thin side a multiuse stick 1900 with a toothed track projecting from a thin side thereof and a matching connector in accordance with an embodiment of the current invention.

### DESCRIPTION OF EXEMPLARY EMBODIMENTS OF THE INVENTION

The present invention, in some embodiments thereof, relates to a multiuse stick and, more particularly, but not exclusively, for lighting and/or entertainment.

### Overview

An aspect of some embodiments of the current invention relates to a multiuse stick. According to some embodiments, multiuse stick may be configured for use as a popsicle stick and/or as a light guide. According to some embodiments, multiuse stick may be configured for use as a toy and/or part thereof. According to some embodiments, multiuse stick may be configured for use as a light guide toy and/or part thereof.

According to some embodiments, the multiuse stick may be used in the manufacture of popsicles, e.g., homemade popsicles, commercially produced popsicles, etc. Optionally, the components of the system may be sold separately and/or together, e.g., as a kit, as a unit, and/or as a toy etc.

Unless specified otherwise, various components described here may include any of the features described as features of a multiuse stick. For example, various accessories describe here (round elements, party favors, accessories, elements of toys (e.g., parts of figures (arms, legs, wheels, wings etc.), and/or decorative elements) of various shapes and sizes) may include light guides, connectors, light sources. Any element may include marking and/or symbols and/or commercial symbols (e.g., trademarks) and/or team logos and/or custom logos and/or photographs and/or group symbols (e.g., flags etc.) and/or slogans, for example, for advertising and/or shows of loyalty and/or protest. Symbols may be printed on a component and/or the component may be include a symbolic and/or familiar form.

According to some embodiments, the multiuse stick may be composed of a light conducting material. Optionally, the light conducting material may be a plastic. Non-limiting examples of suitable materials include: acrylic (polymethylmethacrylate), butyrate (cellulose acetate butyrate), polyvinyl chloride, polycarbonate, polyethylene terephthalate, glycol modified polyethylene terephthalate, polytetrafluoroethylene, polystyrene, polypropylene, polyamide, etc. Optionally, the plastic may have high optical clarity, e.g., acrylic (PMMA), polycarbonate (PC), etc. Optionally, the material may have minimal internal scattering that may disrupt light transmission. Optionally, the material may include one or more light-transmitting additives, e.g., plastics with embedded light-scattering particles, which can improve light diffusion within the stick, which may be especially beneficial for applications requiring even illumination.

According to some embodiments, the stick may, at least in part, be transparent, and/or semi-transparent and/or translucent. Optionally, the stick may be colorless. Optionally, the stick may be colored. Optionally, the stick may be colored, at least in part. Optionally, the stick may be colored by one or more colors, e.g., various sections may be colored differently, e.g., ombre, graduated, alternating colors, etc.

According to some embodiments, the stick may have a length ranging between about 3 cm to about 5 cm, and/or 5 cm to about 7.5 cm, and/or 7.5 cm to about 10 cm, and/or 10 cm to about 15 cm. According to some embodiments, the stick may be cylindrical; flattened, elongated rectangle, optionally, with rounded corners; fun shapes; handles; etc. According to some embodiments, the stick may have a width ranging between about 0.1 cm to 0.5 cm and/or between 0.5 cm to about 1 cm, and/or about 1 cm to about 1.5 cm, and/or about 1.5 cm to about 2 cm. In some embodiments, the thickness of a stick may range between 1 to 3 mm and/or between 0.1 to 1 mm and/or between 3 to 5 mm and/or between 5 to 10 mm.

In some embodiments, a component (e.g., multiuse stick, a connector ring and/or a decorative part) may include a protruding connector. For example, the connector may protrude between 0.1 to 1 mm from a face and/or between 1 to 2 mm from the face and/or between 2 to 4 mm and/or between 4 to 8 mm and/or between 8 to 16 mm from the face.

In some embodiments, a component (e.g., multiuse stick, a connector ring and/or a decorative part) may include a recessed connector. For example, the connector may be recessed between 0.1 to 1 mm from a face and/or between 1 to 2 mm from the face and/or between 2 to 4 mm and/or between 4 to 8 mm and/or between 8 to 16 mm from the face.

In some embodiments, a component (e.g., multiuse stick, a connector ring and/or a decorative part) may include a track connector (e.g., with a rail and/or a groove and/or a line of teeth and/or a ratchet track). Optionally the crests of the teeth and/or tracks may project from a face of the component and/or troughs of the teeth and/or grooves may be recessed from the face. For example, the crests may project and/or troughs may be recessed between 0.1 to 1 mm from a face and/or between 1 to 2 mm from the face and/or between 2 to 4 mm and/or between 4 to 8 mm and/or between 8 to 16 mm from the face. For example, the pitch of the teeth on a ratchet track and/or the distance between connectors on a face of a component may range between 0.05 mm to 0.2 mm and/or between 0.2 mm to 1 mm and/or between 1 mm to 5 mm and/or between 5 mm to 2 cm.

According to some embodiments, the stick may include one or more holes, protrusions, hollows, tracks, threading, clip/s, thicker areas, thinner area, debossing and/or embossing, e.g., to produce a raised image, a depressed image, and/or a colored image. Optionally, the image may be a logo, company name, personal name (e.g., name of a person and/or people and/or company celebrating a particular event), a saying, such as “congratulations”, “Happy New Year”, etc.

According to some embodiments, the stick may be incorporated into a popsicle. Optionally, the stick may support the frozen portion of the popsicle. Optionally, the distal portion of the stick may support the frozen portion of the popsicle. Optionally, the proximal portion of the stick may be used as a handle e.g., to hold the popsicle. Optionally, the popsicle may include a frozen liquid. Optionally, the frozen liquid may include water, dairy, lactose-free dairy, dairy substitute, fruit, juice, food coloring, flavoring, etc. Optionally, the frozen liquid may be, at least in part, transparent, semi-transparent, translucent, and/or opaque. Optionally, the frozen liquid may be light conducting, at least in part. Optionally, the popsicle may appear to glow when one or more LEDs in and/or on the stick are turned on.

According to some embodiments, the stick may be attached to one or more LEDs. Optionally, the stick may be attached to one or more LEDs while incorporated into a popsicle. Optionally, the stick may be attached to one or more LEDs prior to and/or after incorporation into a popsicle. Optionally, the stick may be attached to one or more additional components, e.g., additional sticks, decorative elements, holding elements (such as a lanyard, necklace, bracelet, holder, etc.), and/or any combination thereof.

According to some embodiments, the popsicle may be consumed while the stick is attached to a light emitting unit. Optionally, the popsicle may be consumed prior to attachment to a light emitting unit.

According to some embodiments, the LEDs may produce light having a frequency ranging between about 100 nm to about 800 nm, and/or about 300 nm to about 635 nm, and/or between about 450 nm to about 700 nm, and/or between about 500 nm to about 600 nm. According to some embodiments, the visible light may be affected by the color of the light emitted by an active LED and/or by the color and transmissivity of the popsicle and/or stick. Advantageously, a large variety of colors and/or light intensity may be made possible by controlling the operating LEDs and/or the popsicle composition and/or the popsicle stick.

According to some embodiments, the color of the glowing popsicle may be derived from one or more colored LEDs. According to some embodiments, the color of the glowing popsicle may be derived from the stick being colored, at least in part. Optionally, various portions of the light guide stick may have different colors. Optionally, the popsicle and/or popsicle stick may include one or more light guides. Optionally, the light guides may have different colors in different areas and/or use a single-colored external LED (e.g., a white LED). According to some embodiments, one or more LEDs embedded in the stick may provide various colors. Optionally, the LED lights may be activated and/or deactivated simultaneously, sequentially and/or manually, e.g., a user may use a user interface to control the number and/or color and/or blink rate of LEDs. Optionally, the user interface may not provide the user with control of the LEDs, e.g., the user interface may be a simple switch. According to some embodiments, the light guide stick may be a single color. According to some embodiments, the popsicle itself may be colored. Optionally, the use of LEDs may reduce the need for food coloring, e.g., instead of a colored frozen liquid, a colored stick and/or colored LEDs are used to color the popsicle.

According to some embodiments, the LED light may be clearly visible during the day and/or at night. Optionally, the LED light may have a minimum effective luminous intensity of at least about 2.5 cd (candela), and/or at least 5 about cd (candela), and/or at least about 10 cd (candela), and/or at least about 20 cd (candela). According to some embodiments, the light may comprise a plurality of light emitting diodes (LED) lights. Optionally, the plurality of LEDs may be mounted in parallel and/or in series. Optionally, the plurality of LEDs may be positioned as two or more sets of LEDS. Optionally, the two or more sets of LEDS may be positioned at an angle to each other, e.g., at an angle ranging between about 45° to about 135°, and/or between about 60° to about 120°, and/or between about 75° to about 105°.

According to some embodiments, the stick may be attached to one or more LEDs. Optionally, the LEDs may be included within the stick. Optionally, the LEDs may be included in a light emitting unit. Optionally, the light emitting unit may be connected to the base of the stick. Optionally, the light emitting unit may be included within the stick. Optionally, the light emitting unit may be reversibly attached and/or detached from the stick. Optionally, the light emitting unit may be attached to the stick, or part thereof through a connector. Optionally, the connector may be a protrusion, hole, clip, threading, screw, hollow, pin, etc. Optionally, the stick may include a first connector and the light emitting unit may include a second connector. Optionally, the first and second connectors may connect to each other.

According to some embodiments, the light emitting unit may include a controller. Optionally, the controller may be a printed circuit board (PCB). Optionally, the controller may be connected to one or more LED lights. Optionally, the controller may be configured for operating the light emitting unit in one or more operating modes. Optionally, the controller may control the identity of the operating LED in accordance with its location and/or color. Optionally, the controller may control the LEDs in the temporal domain. Optionally, the controller may induce a desired complex series of LED lighting, e.g., sequential operation, simultaneous operation, flashing, rate of flashing, etc. Optionally, the light emitting unit may include a battery for empowering the controller and the LEDS, either directly and/or via the controller. Optionally, the light emitting unit may include a user interface. Optionally, the user interface may activate and/or deactivate one or more LEDs. Optionally, the user interface may be configured for manual interfacing the controller.

According to some embodiments, the light emitting unit may be a sealed unit. Optionally, the light emitting unit may be water tight. Optionally, the light emitting unit may be water proof Optionally, the light emitting unit may be opaque, translucent, transparent, and/or semi-transparent. Optionally, the light emitting unit may include one or more LEDs. Optionally, the light emitting unit may include one or more reflectors. Optionally, the light emitting unit may include one or more lenses. Optionally, the lens may protect the LED lights from the environment. Optionally, the lens may adjust the color of the visible light observed from the LED lights. Optionally, the lens may increase the intensity and/or brightness of the LED lights.

According to some embodiments, the stick may be attached to one or more additional sticks. Optionally, the sticks may be attached to each other through various holes and/or protrusions and/or slits on the sticks themselves. Optionally the sticks may be attached to each other by one or more additional connectors, e.g., clips, pins, screws, hollows, gears, etc. Optionally, the sticks may be used as construction toys. Optionally, the sticks may interlink. Optionally, the sticks may be used to build anything.

According to some embodiments, the sticks may connect to one or more additional components, e.g., decorative components, structural components, etc. Optionally, the sticks and/or additional components may be used to build anything, limited only by the user's imagination, e.g., vehicles, buildings, robots, rockets, animal figures, items inspired by popular culture and/or social media, etc. Optionally, one or more sticks may be connected to a light emitting unit while in use in a toy.

According to some embodiments, the stick design may facilitate attachment of one or more light emitting units to one or more additional sticks, additional components and/or additional connectors. Optionally, the sticks and/or additional components and/or additional connectors may be reusable, e.g., a constructed item may be easily taken apart and/or reused to create new things. Optionally, this may encourage open-ended play and/or spark creativity.

According to some embodiments, a multiuse stick may be included in a kit for preparing homemade popsicles. Optionally, the kit may include one or more multiuse sticks, one or more molds, and a plurality of one or more light emitting diodes (LEDs). Optionally, the mold may be for a specific shape, e.g., a figure (such as, an animal, a person, a building, a robot, a rocket, a figurine, fruit, etc.), an ice-cream, etc. Optionally, several different molds may be provided. Optionally, the mold may be a household item, e.g., a cup, bowl, cupcake pan, disposable cup, etc.

According to some embodiments, the popsicle may be produced commercially. Optionally, the popsicle may be packaged for sale. Optionally, the package may include a kit. Optionally, the kit may include the popsicle with the multiuse stick. Optionally, the kit may include the popsicle with the multiuse stick and one or more additional components and/or additional connectors. Optionally, the kit may include the popsicle with the multiuse stick and a light emitting unit. Optionally, the kit may include the popsicle with the multiuse stick, a light emitting unit, and/or one or more additional components and/or additional connectors. Optionally, a kit may include popsicle stick/s and/or light emitting units. Optionally, a kit may include popsicle stick/s and/or light emitting units and/or molds. Optionally, a kit may include the components required to make a party favor. Optionally, a kit may include the components required to make a toy. Optionally, a kit may include the components required to make a homemade popsicle. Optionally, various light emitting units may be sold separately, e.g., various colors, various intensities, various lighting types (such as, flickering, sequential lighting, multiple lighting modes, etc.). Optionally, various additional components and/or additional connectors may be sold separately. Optionally, additional sticks may be sold separately. Optionally, sticks of various designs may be sold separately.

According to some embodiments, the kit may include a controller for operating the light emitting unit in a plurality of one or more operating modes. Optionally, the kit may include a user interface for manual interfacing the controller. Optionally, the kit may include a battery for empowering the controller and the LEDS, either directly or via the controller. Optionally, the battery may be rechargeable.

According to some embodiments, a glowing popsicle may be prepared by:
1. Connecting a light emitting unit to a light transmitting stick, to produce an integrated light guide.
2. Preparing a liquid suitable for a popsicle.
3. Pouring the liquid into a mold.
4. Positioning the stick or the integrated light guide in the center of the mold, such that the stick is surrounded on all sides by the liquid but projects therefrom.
5. Freezing the liquid.
6. Removing the popsicle from the mold.
7. Operating the light guide to manifest a glowing popsicle.

According to some embodiments, the glowing popsicle may be eaten. According to some embodiments, the stick and/or a component thereof may be non-toxic, and/or child safe. According to some embodiments, the light emitting unit and/or a component thereof may be non-toxic, and/or child safe. According to some embodiments, the use of colored LEDs and/or lenses and/or sticks may reduce the use of food colorants in the manufacture of popsicles.

According to some embodiments, the popsicle sticks may be reused, and/or recycled. Optionally, the kits and/or components thereof may be reused and/or recycled. Optionally, the kits and/or components thereof may be constructed from recycled materials.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to the figures.

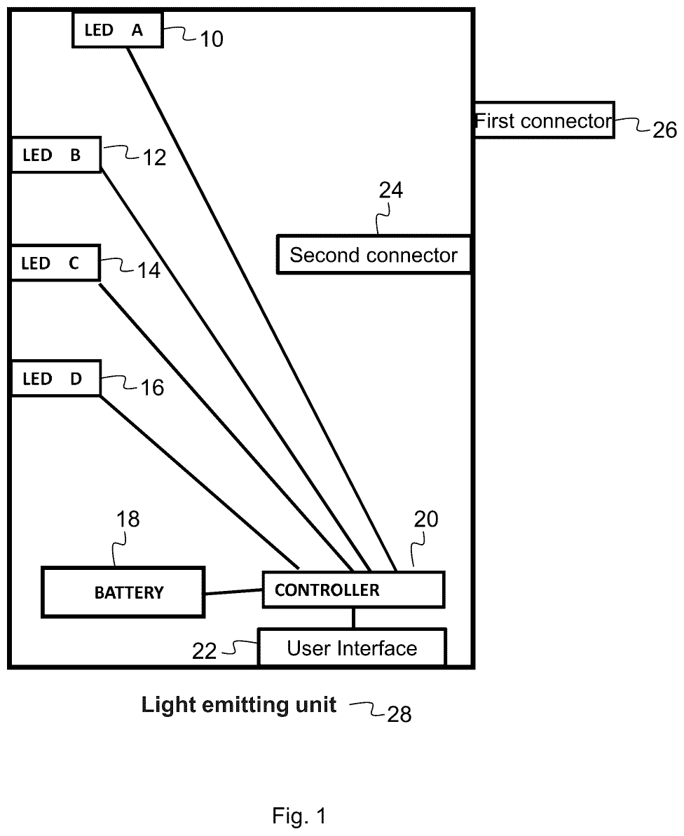

FIG. 1 is a block diagram of a multiuse stick, in accordance with some embodiments. According to some embodiments, the multiuse stick may include a light emitting unit connected to a light conducting stick. Optionally, the light emitting unit may be connected to and/or, at least in part, incorporated within the stick. For example, light emitting unit 28, may include one or more LEDs (e.g., 10, 12, 14, and 16) connected to a controller 20, powered by a battery 18, and attached to a user interface 22. The stick may be connected to light emitting unit 28 through a first connector 26 connected to a second connector 24. Optionally, LEDs 10, 12, 14, and 16 may be the same color. Optionally, LEDs 10, 12, 14, and 16 may be different colors. Optionally, LEDs 10, 12, 14, and 16 may be positioned in various locations along the stick and/or the light emitting unit.

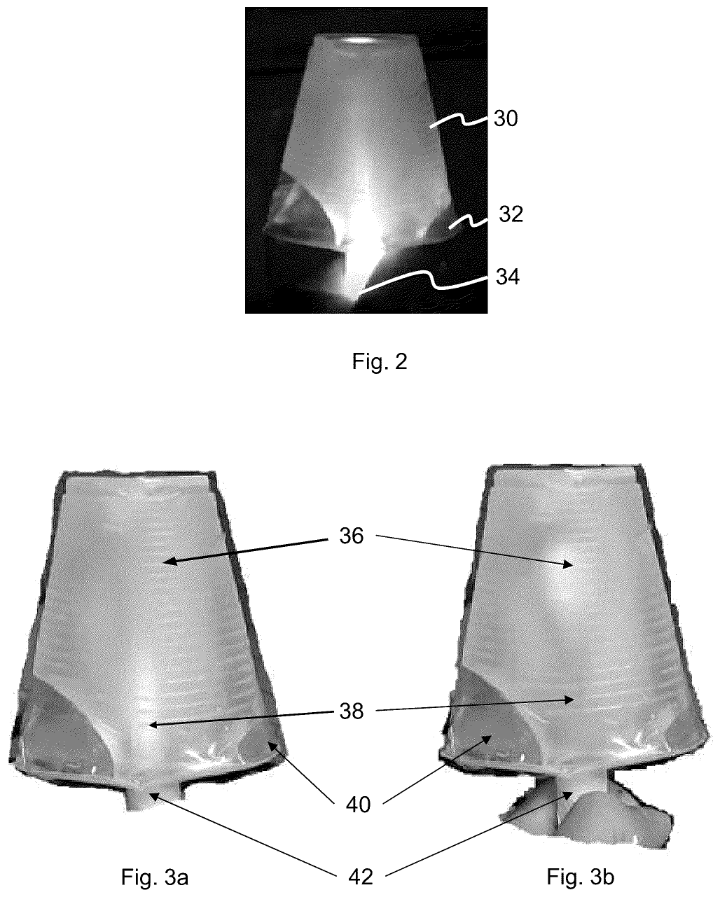

FIG. 2 is an exemplary image of a multiuse stick as a light guide with an external light source connected to a homemade popsicle made in a plastic mold, in accordance with some embodiments. For example, a user may hold the stick on its lower portion which may protrude from the frozen popsicle and/or mold while the upper portion may be positioned within the frozen popsicle. The mold may be a disposable plastic cup 32. Additional non-limiting examples of suitable molds may include: prefabricated molds of specific shapes, e.g., a figure (such as, an animal, a person, a building, a robot, a rocket, a figurine, a fruit, etc.), a household item, e.g., a cup, bowl, cupcake pan, disposable cup, etc. The frozen popsicle 30 may be a frozen liquid including one or more of water, dairy, lactose-free dairy, dairy substitute, fruit, juice, food coloring, flavoring, etc. Optionally, the frozen liquid may be, at least in part, transparent, semi-transparent, translucent and/or opaque. The stick may be connected to an external light emitting unit 34. The light emitting unit 34 may produce light from one or more LEDs. The stick may be configured to function as a light guide, e.g., transmitting and/or conducting light from light emitting unit 34 through the popsicle 30 to make it light up and/or glow. Optionally, the LEDs may have various colors and/or intensities. Optionally, the amount of visible light and/or the color of the visible light may be determined by a variety of factors including: color of the LED/s, color of the stick, color of the stick along its length, color of the lens/es, color of the frozen liquid, amount of colorant and/or color of colorant added to the liquid prior to freezing, opacity of the stick, opacity of the frozen liquid, etc.

FIGS. 3A-B are exemplary images of a stick used as a light guide with an internal light source in a homemade popsicle made in a plastic mold, in accordance with some embodiments. For example, a user may hold the stick 44 on its proximal (e.g., lower) portion which may protrude from the frozen popsicle and/or mold 40 while the distal (e.g., upper) portion may be positioned within the frozen popsicle. The stick 44 may include a plurality of one or more LEDs 36, 38. LEDs 36, 38 may be positioned along the stick. LEDs 36, 38 may emit light at a plurality of colors. Optionally, the LEDs may emit light simultaneously and/or sequentially (e.g., FIGS. 3A and 3B). Optionally, the LEDs may be turned on and/or off automatically and/or manually. Optionally, the color and/or intensity of the light emitted by the LEDs may be controlled by a controller. Optionally, the color and/or intensity of the light emitted by the LEDs may be controlled automatically and/or manually.

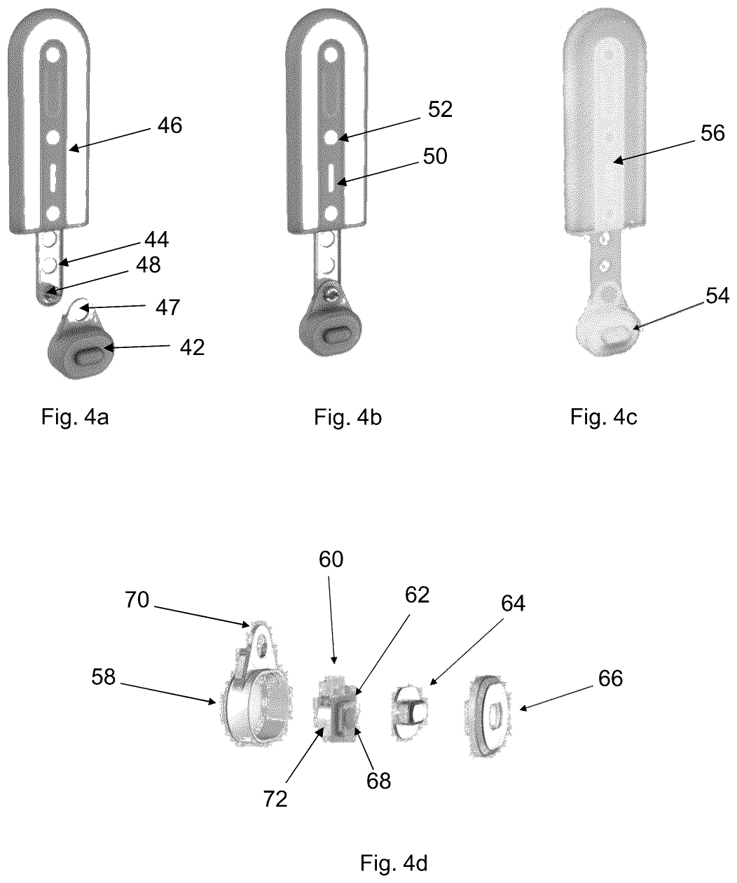

FIGS. 4A-C are various views of a glowing popsicle with an external light source and a light guide popsicle stick, in accordance with some embodiments. For example, the external light source may be a light emitting unit 42. Optionally, light emitting unit 42 may be reversibly attached and/or detached from stick 44. Optionally, light emitting unit 42 may be attached to stick 44 while stick 44 is at least partially contained within the frozen liquid of popsicle 46. Optionally, light emitting unit 42 may be attached to stick 44 by a connector (e.g., a protrusion, hole, clip, threading, screw, hollow, pin, etc.). Optionally, stick 44 may include first connector 48 and light emitting unit 42 may include second connector 47. Optionally, first connector 48 and second connector 47 may connect to each other. Optionally, light emitting unit 42 may include a controller and/or a user interface 54. Optionally, user interface 54 may manually turn on and/or off one or more LEDs in light emitting unit 42. Optionally, user interface 54 may turn on and/or off various lighting modes. Optionally, stick 44 may include various holes 50, voids 52, and/or protrusions (e.g., first connector 48). Optionally, the stick may be optimized for light conduction (e.g., size, thickness, width, holes, protrusions, etc.). Optionally, the stick may be, at least in part, hollow. Optionally, light emitting unit 42 may fit into a hollow at the base of stick 44. Optionally, popsicle 46 may glow 56 when light emitting unit 42 is activated by the user interacting with user interface 54.

FIG. 4D is an exploded view of an external light source and a light guide multiuse stick, in accordance with some embodiments. For example, light emitting unit 42 may include housing 58, optionally including a connector 70. Housing 58 may hold one or more batteries 72, which may optionally be rechargeable and/or replaceable. Batteries 72 may be connected to one or more LEDs 60 and/or a controller 62 (e.g., printed circuit board, etc.) and/or a switch 68. Optionally, the switch may be part of and/or connected to a user interface 64. Optionally, housing 58 may be sealed with a cover 66. Optionally, the seal may be water proof.

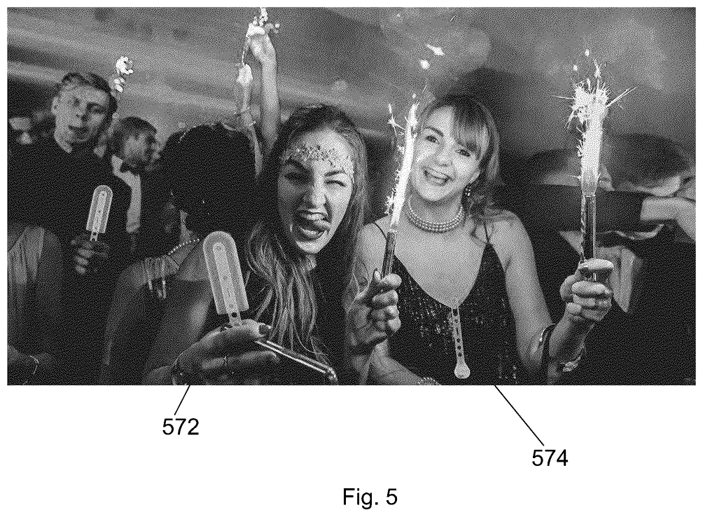

FIG. 5 is a schematic image of use of the multiuse stick as a party favor, in accordance with some embodiments. For example, a popsicle may include and/or be connected to a light emitting unit. The light emitting unit may be connected to a light conducting stick (e.g., light guide). When the light emitting unit is activated, the popsicle may glow. The popsicle may be eaten while glowing 572 without worrying about toxic materials and/or effects. Once eaten, the glowing stick 574 may continue to emit light. Optionally, the glowing stick may be connected to a lanyard, necklace, belt, bracelet, headband, etc. Optionally, glowing popsicles may be distributed at an event, e.g., birthday party, wedding, company celebration, concert, disco, rave, etc. Optionally, an individual may purchase one or more glowing popsicles for themselves, friends, family etc. as a novelty. Optionally, the stick may include a name and/or logo embossed, debossed, and/or printed thereon and/or therein. Optionally, sticks may be molded in the shape of letters and/or symbols and/or may be connected to form letters and/or symbols (e.g., a birthday cake, a candle, a heart, a fist, a bird etc.). Alternatively or additionally, a stick may have symbols and/or phrases (e.g., happy birthday, happy anniversary, get well). The stick may be used as a flag pole and/or handle and/or stand for various signs and/or flags and/or symbols and/or messages. In various embodiments, the sticks may be used for various products (e.g., cotton candy, ice cream, popsicles, lollipops, coffee stirrers, play utensils (e.g., for sandboxes and/or modeling dough (e.g., Play-Doh)). In some embodiments, the sticks may also be formed as cutlery (e.g., a spoon, knife or fork). In some embodiments, lights may be arranged in temporal and/or geometric forms. For example, a light may flash green and red at intervals (random and/or patterned) for a game and/or randomly flash colors for use as a random game object (e.g., like dice) and/or in a geometric form (e.g., as a traffic light).

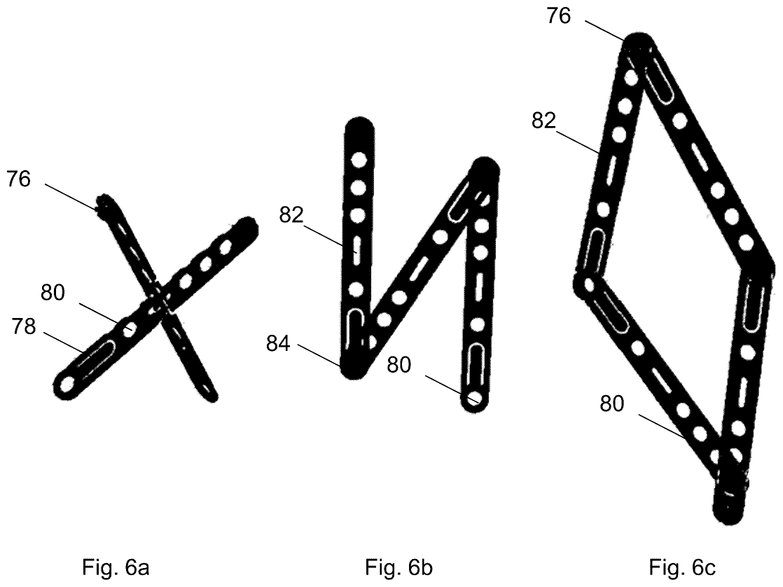

FIGS. 6A-C are schematic images of various ways of using popsicle sticks as a construction toy, in accordance with some embodiments. For example, two or more popsicle sticks may be reversibly connected to each other through holes 80, protrusions 76, slits 82, etc. Optionally, additional connectors, such as pins 84, flexible connectors 78 (e.g., tongue that connect like a paper clip), may be used to connect two or more sticks. Optionally, one stick may slide through a slit in the other stick and/or be rotated to fix and/or release the connection. Optionally, the holes may include teeth e.g., to fix the angle of connection.

According to some embodiments, the stick may be attached to one or more additional sticks. Optionally, the sticks may be attached to each other through various holes and/or protrusions on the sticks themselves. Optionally the sticks may be attached to each other by one or more additional connectors, e.g., clips, pins, screws, hollows, gears, etc. Optionally, the sticks may be used as construct toys. Optionally, the sticks may interlink. Optionally, the sticks may be used to build anything limited only by the user's imagination, e.g., vehicles, buildings, robots, rockets, animal figures, items inspired by popular culture and/or social media, etc.

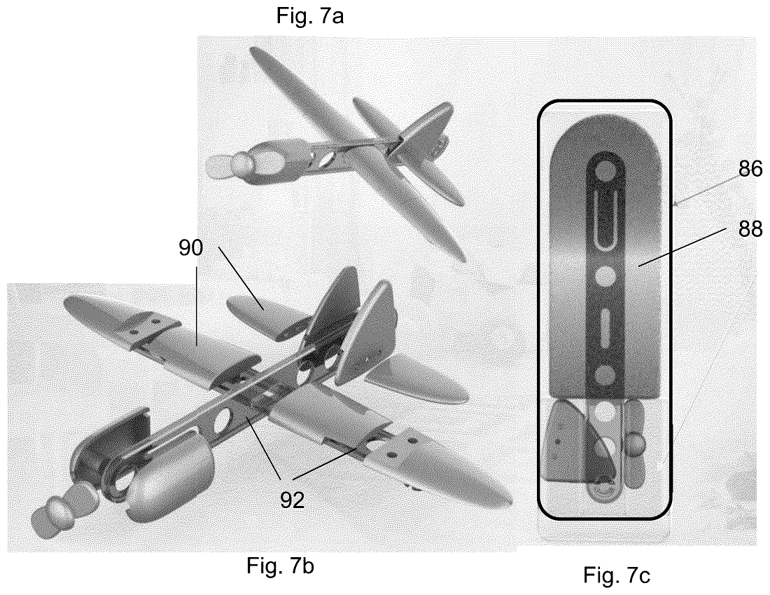

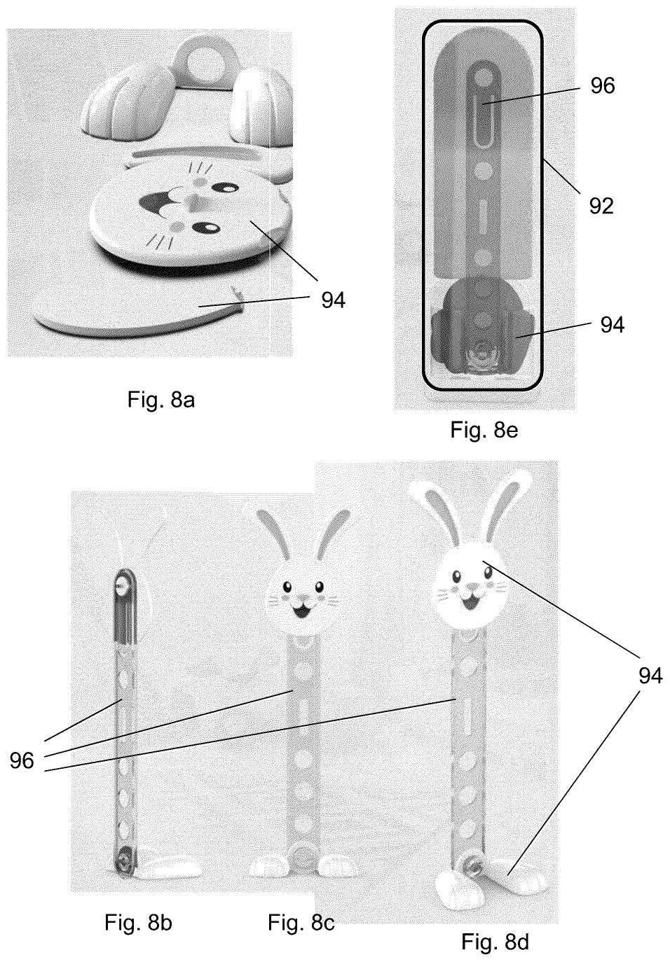

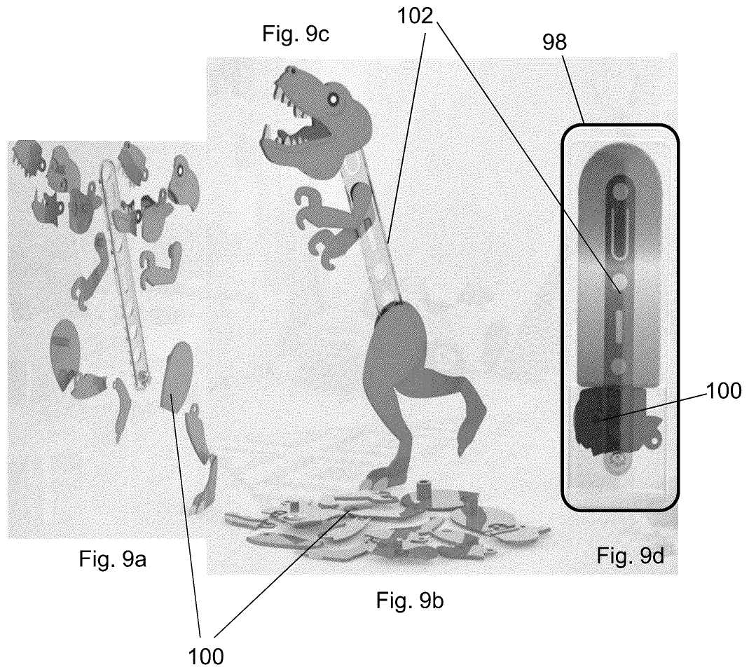

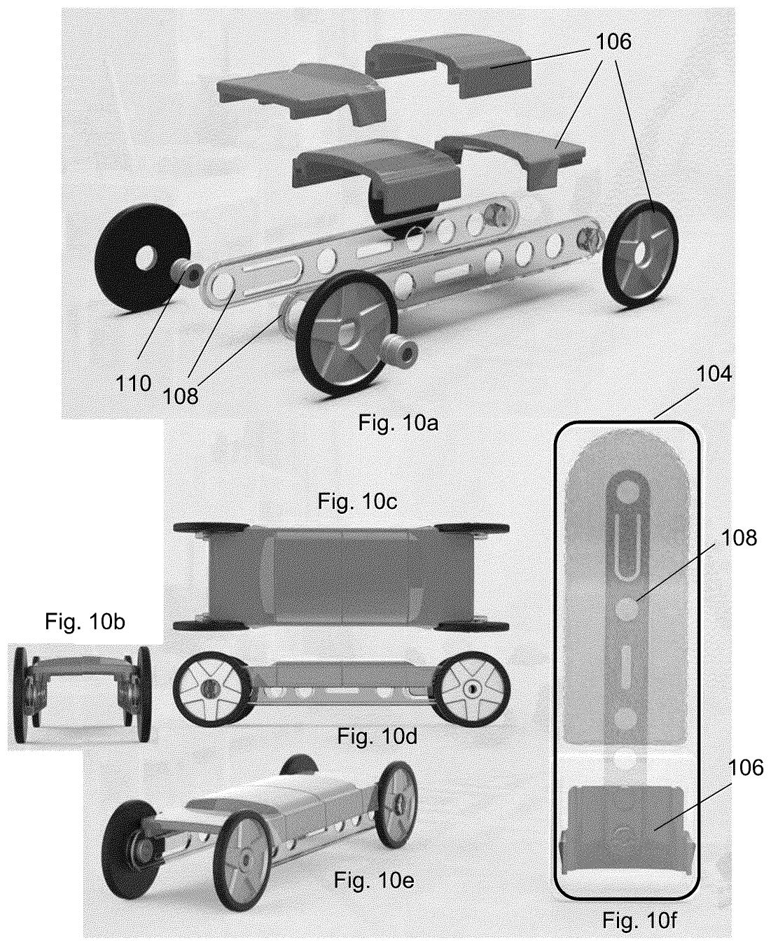

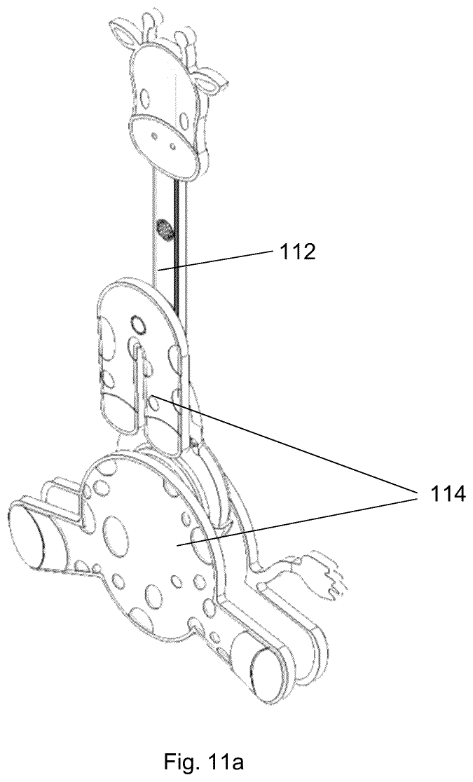

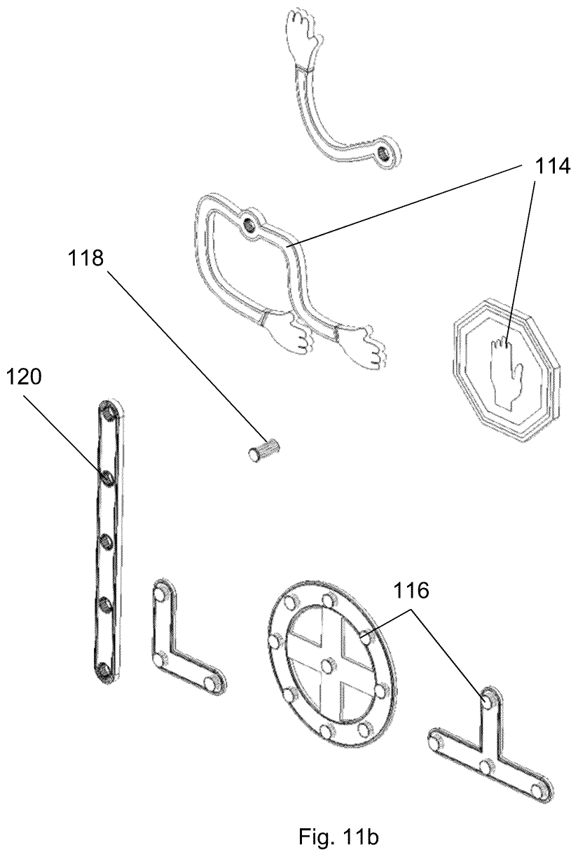

FIGS. 7A-C, FIGS. 8A-E, FIGS. 9A-D, FIGS. 10A-F, and FIGS. 11A-B are schematic images of exemplary toys constructed from one or more sticks, in accordance with some embodiments. For example, a glowing popsicle kit may be included in a package (e.g., FIGS. 7C, 8E, 9D, and 10F). Optionally, the package 86, 98, 104 may include a popsicle 88 with a light guide stick 92, 96, 102, 108, 112 embedded therein and one or more additional components 94, 100, 106, 114 and/or one or more additional connectors 110, 118 and/or a light emitting unit (not shown). Optionally, the additional components 94, 100, 106, 114 may be connected to the light guide stick 92, 96, 102, 108, 112 by one or more additional connectors 110, 118. Optionally, the additional components for example decorative components 90, 94, 100, 106, 114 may be connected to the light guide stick 92, 96, 102, 108, 112 by one or more holes 120 and/or protrusions 116 located on the stick and/or additional components. Optionally, the one or more additional components may be decorative components and/or structural components. Optionally, connection of one or more additional components to the stick and/or sticks may construct one or more toys, e.g., an animal, a car, an airplane, a traffic signal, etc. Optionally, the toy may be capable of standing (e.g., self-standing such as, FIG. 8D, FIG. 11A). Optionally, one or more of the additional components (e.g., wheels and/or joints and/or hinges and/or axles) of the toy may be capable of moving (e.g., FIG. 9C) and/or facilitating motion (e.g., FIGS. 10A-E, FIG. 11B). Optionally, more than one stick may be used to construct the toy (e.g., FIG. 7B, FIGS. 10A-E). Optionally, construction of the toy may make use of components from more than one package. Optionally, the additional components may connect to each other to produce more complex toys e.g., articulated toys. Optionally, the connectors may include teeth and/or shapes and/or sizes, which may ensure that only specific components fit each other. Optionally, the connectors may include teeth to ensure that the components are connected at specific angles (e.g., FIG. 11B). Optionally, one or more sticks may be connected to a light emitting unit while in use in a toy.

According to some embodiments, the stick design may facilitate attachment of one or more light emitting units in addition to one or more additional sticks, additional components and/or additional connectors. Optionally, the sticks and/or additional components and/or additional connectors may be reusable, e.g., a constructed item may be easily taken apart and/or reused to create new things. Optionally, this may encourage open-ended play and/or spark creativity.

According to some embodiments, the toy may include a light emitting unit which may include a single color and/or single LED. Optionally, the toy may include a light emitting unit which may include multiple colors multiple LEDs and/or a stick with multiple light paths and/or colors.

According to some embodiments, the toy may include two popsicle sticks with one sliding through a slit in the other, optionally perpendicular (e.g., FIGS. 7A-B). Alternatively, or additionally, the toy may include different angles and/or use more sticks. Optionally, a toy may use two sticks in parallel and/or in parallel planes (e.g., FIGS. 10A-E). Alternatively, or additionally, the sticks may be angled with respect to each other and/or in planes that are angled and/or the sticks may be in same plane. According to some embodiments, the toy may be the width of the package and/or popsicle. Optionally, two or more components may be connected to each other to produce a toy with a width greater than the width of the package. Optionally, the components may be configured to fit into the popsicle packaging.

According to some embodiments, a component may be connected to the distal end of the light guide. Optionally, the distal component may include an image. Optionally, the image may be projected by the light from the light emitting unit and/or LEDs within the stick passing through the light guide and the image. Optionally, the image may be a logo, name, animal, image from social media and/or popular culture.

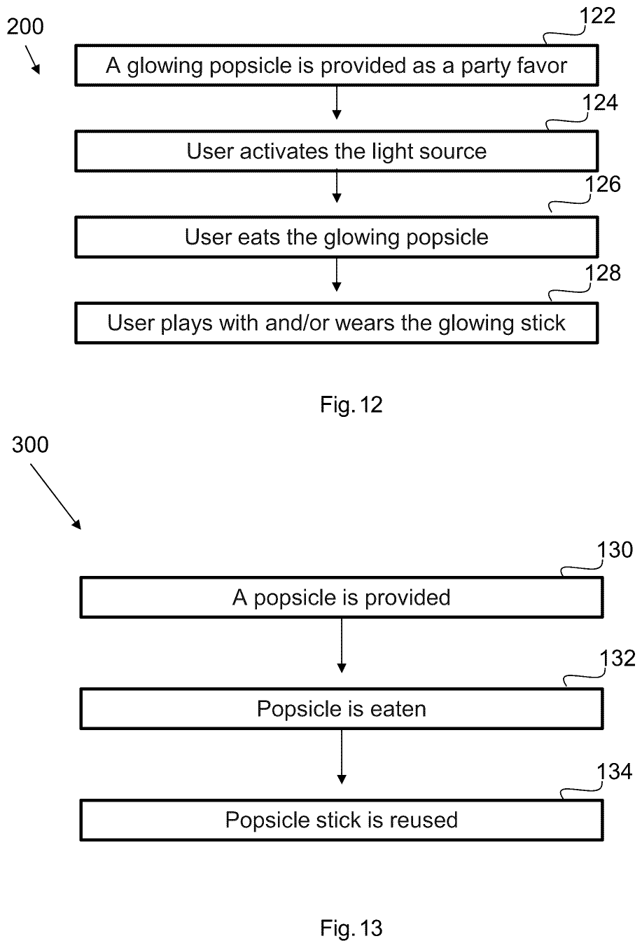

FIG. 12 is a flow chart for use of a multiuse stick, in accordance with an embodiment of the current invention. For example, in method 200, a popsicle with light source pay be provided 122 as a party favor. Optionally, the user may eat the popsicle and then activate the light source to play with and/or wear the glowing stick. Optionally, the user may activate 124 the light source prior to consumption of the popsicle. Optionally, the user may then eat 126 the glowing popsicle. Optionally, the user may then play with and/or wear 128 the glowing stick.

FIG. 13 is a flow chart for use of a reusable multiuse stick, in accordance with an embodiment of the current invention. For example, in method 300, a popsicle with a reusable stick is provided 130. The popsicle may be eaten 132 by the user, and the stick is reused 134. Optionally, the stick may be reused as a party favor. Optionally, the stick may be reused as a toy, and/or part thereof. Optionally, additional components may be connected to the party favor and/or toy. Optionally, a light source may be included for use as a toy and/or party favor. Optionally, the components and the popsicle may be packaged together, e.g., in a kit. Optionally, the additional components may be supplied and/or purchased separately. Optionally, additional components and/or additional connectors may be used in the construction of a toy.

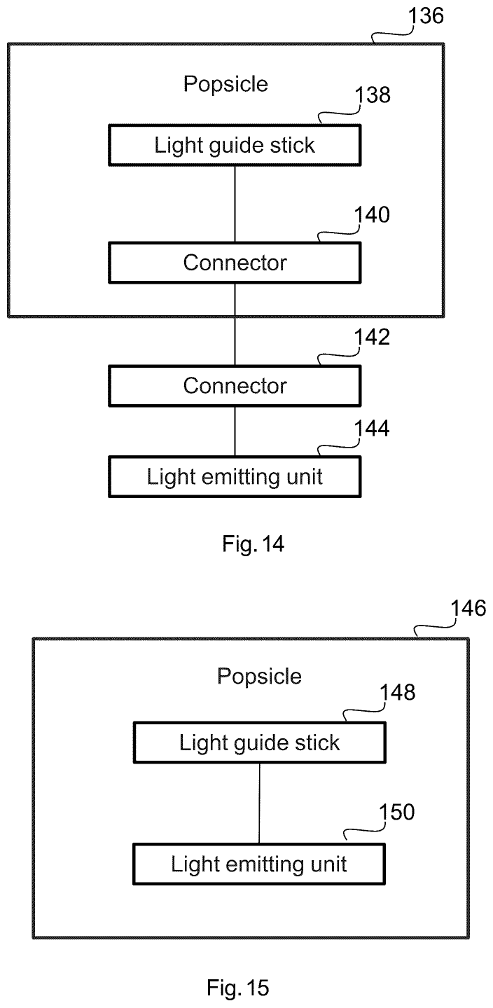

FIG. 14 is a block diagram of a light guide stick, in accordance with an embodiment of the current invention. For example, a popsicle 136 may include a reusable light guide stick 138. Optionally, stick 138 may include one or more LEDs. Stick may include a connector 140 for connection to a connector 142 of a light emitting unit 144. Light emitting unit 144 may include one or more LEDs, a controller, a battery, and/or a user interface. In some embodiments, the stick 138 and/or connector may be inside the popsicle, partially inside the popsicle and/or outside the popsicle.

FIG. 15 is a block diagram of a light guide stick, in accordance with an embodiment of the current invention. For example, a popsicle 146 may include a reusable light guide stick 148 containing a light emitting unit 150. Light emitting unit 150 may include one or more LEDs, a controller, a battery, and/or a user interface.

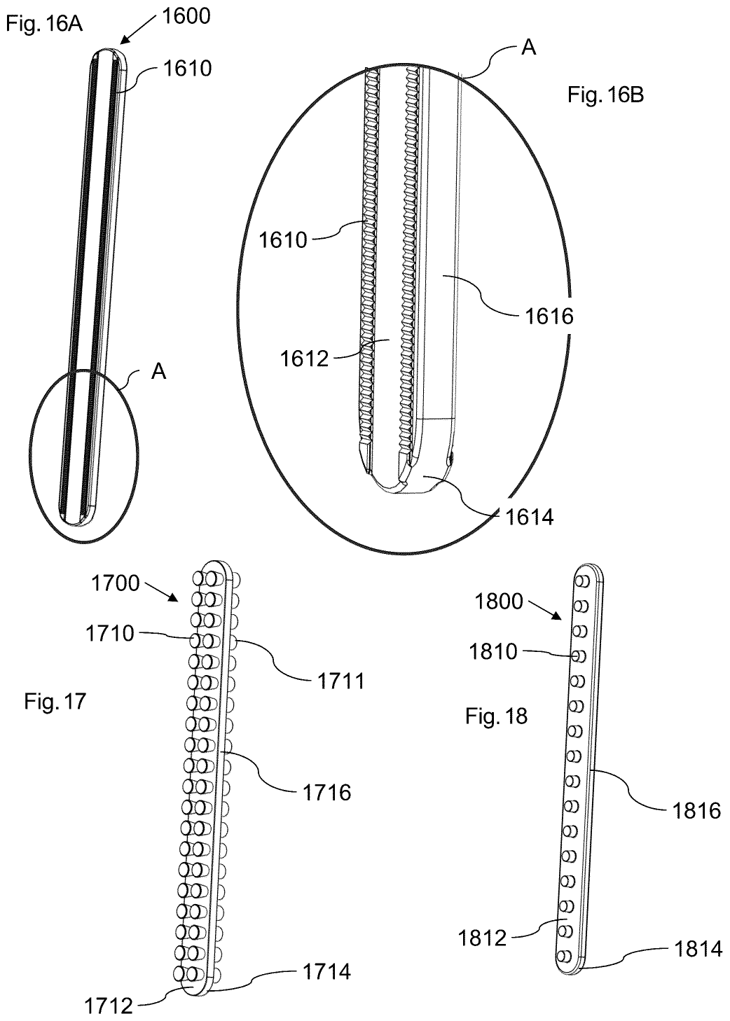

FIGS. 16A and 16B illustrate a component (e.g., a multiuse stick) with a ratchet track (e.g., a toothed track) projecting from a wide face thereof in accordance with an embodiment of the current invention. In some embodiments, a multiuse stick 1600 may include a connector 1610 protruding from the stick. For example, the projecting connector 1610 may leave the cross section of the stick clear and/or facilitate increased light conductance.

In some embodiments, the stick 1600 includes a wide front face 1612 and/or a thin side face 1616. For example, the one or more connectors 1610 may project from the front face. In some embodiment, the connector 1610 may include a toothed track. For example, the track may include triangular teeth that can serve as interference elements and/or a track for a ratchet mechanism. Additionally or alternatively, the connector 1610 may serve to hold a popsicle (preventing the stick 1600 from slipping with respect to the popsicle). Optionally, a track may extend along the entire length of the stick 1600. For example, two tracks may be distributed symmetrically across a front face 1612 of the stick. Alternatively or additionally, a track may extend along a portion of the length of the stick (for example, more than 90% and/or between 70 to 90% and/or 30 to 50% of the length of the stick.

In some embodiments, the front face 1612 of a stick 1600 may include a portion configured to glow when the stick is exposed to light. For example, the smooth portion may run the length of the stick. Optionally the smooth portion is in the center of the stick between connector 1610 tracks. Additionally or alternatively, a smooth portion of a face may surround a connector and/or a connector may be in the middle of a face. For example, the smooth portion may occupy between 80 to 100% of the face and/or between 50 to 80% and/or between 20 to 50% of the face. Optionally, a smooth portion of the stick 1600 may be parallel (protrude equally) to the troughs of the teeth of a track of connectors 1610. Alternatively or additionally, the smooth portion of the stick 1600 may be parallel to the crests of the teeth of a track of connectors 1610. Alternatively or additionally, the smooth portion of the stick 1600 may protrude more than the crests of the teeth of a track of connectors 1610. Alternatively or additionally, the smooth portion of the stick 1600 may sunken more than the troughs of the teeth of a track of connectors 1610. Alternatively or additionally, the smooth portion of the stick 1600 may protrude to an extent in the middle of the teeth of a track of connectors 1610. Optionally, an end 1614 of the stick 1600 may be rounded and/or squared.

In some embodiments, the stick 1600 includes a side face 1616 that is thinner than the front face 1612. For example, the thickness of the stick 1600 (e.g., the width of the side face 1616) may be between 50 to 80% the width of the stick 1600 (e.g., the width of the front face 1612) and/or thickness of the stick 1600 may be between 20 to 50% the width of the stick 1600 and/or thickness of the stick 1600 may be between 80 to 100% the width of the stick 1600. Optionally, the side face 1616 is configured to glow when light is applied to the stick 1600. For example, the side face 1616 may be smooth.

Optionally one or more tracks may project from and/or be recessed into a single face of a component (e.g., stick 1600). Alternatively or additionally, tracks may project and/or be recessed into opposing faces of the component. In some embodiments, a track may be linear. Alternatively or additionally, a track may circular and/or curved. A track may have an open form (e.g., a line and/or a semicircle) and/or closed form (e.g., a circle and/or an oval etc.).

FIG. 17 is an illustration of a component (e.g., a multiuse stick 1700) with connectors projecting from opposite wide faces thereof in accordance with an embodiment of the current invention. For example, connectors 1710, 1711 may protrude from a wide face 1712 of a stick 1700. For example, projections may be cylindrical and/or have an overhang and/or have a taper. Optionally, another component may have complementary connectors. For example, protruding connectors 1710, 1711 may connect to recessed connectors and/or cavities in another component (for example, with tubes and studs like Lego©). For example, stick 1700 includes two lines of projections 1710, 1711 along opposing wide faces of the stick 1700. Alternatively or additionally, connectors may be positioned on side faces 1716 of the stick 1700. Optionally, an end 1714 of the stick 1700 may be rounded and/or squared.

FIG. 18 is an illustration of a component (e.g., a multiuse stick 1800) with connectors projecting from opposite wide faces thereof in accordance with an embodiment of the current invention. For example, connectors 1810 may protrude from a wide face 1812 of a stick 1800. For example, projections may be cylindrical and/or have an overhang and/or have a taper. Optionally, another component may have complementary connectors. For example, protruding connectors 1810 may connect to recessed connectors and/or cavities in another component (for example, with tubes and studs like Lego©). For example, stick 18700 includes a line of projections along a wide face of the stick 1800. Optionally, the opposing face of the stick 1800 is smooth. Alternatively or additionally, connectors may be positioned on side faces 1816 of the stick 1800. Optionally, an end 1814 of the stick 1800 may be rounded and/or squared.

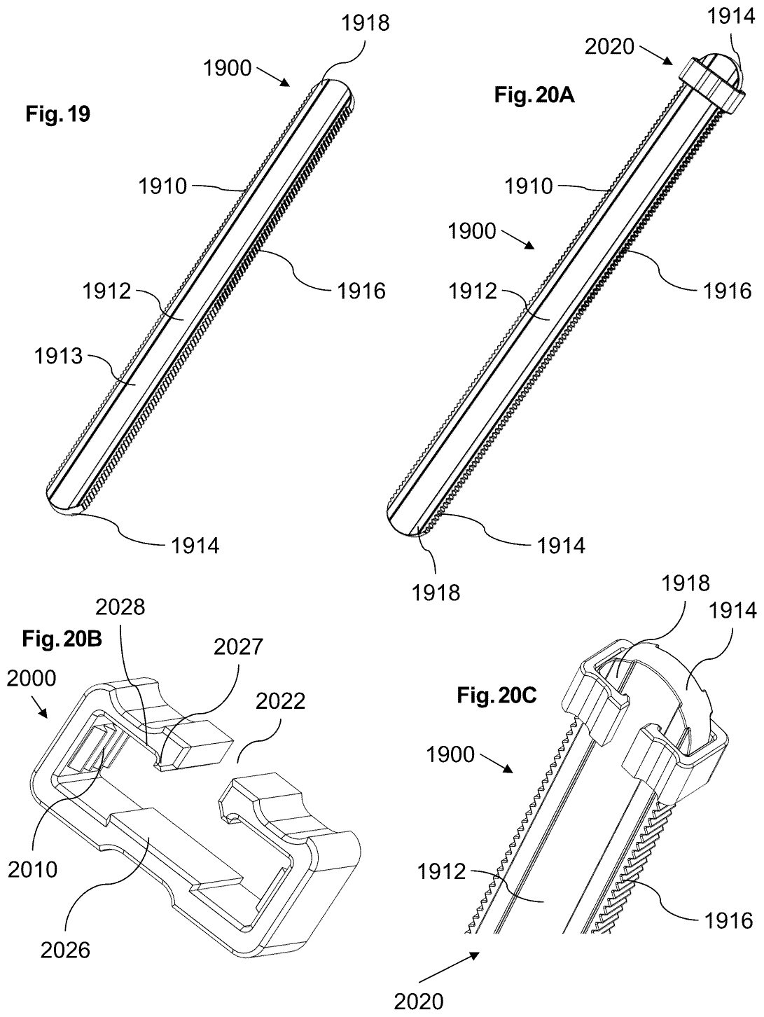

FIG. 19 illustrates a component (e.g., a multiuse stick) with a ratchet tracks (e.g., a toothed tracks) projecting from a side face of the stick in accordance with an embodiment of the current invention. In some embodiments, a multiuse stick 1900 may include a connector 1910 protruding from the stick. For example, the projecting connector 1910 may project from a side face of the stick and/or leave the cross section of the stick clear and/or facilitate increased light conductance.

In some embodiments, the stick 1900 includes a wide front face 1912 and/or a thin side face 1916. For example, the one or more connectors 1610 may project from the side face. In some embodiment, connectors 1910 may include a toothed track. For example, the tracks may include triangular teeth that can serve as interference elements and/or a track for a ratchet mechanism. Additionally or alternatively, the connector 1910 may serve to hold a popsicle (preventing the stick 1900 from slipping with respect to the popsicle). Optionally, a track may extend along the entire length of the stick 1900. Alternatively or additionally, a track may extend along a portion of the length of the stick (for example, more than 90% and/or between 70 to 90% and/or 30 to 50% of the length of the stick.

In some embodiments, the front face 1612 of a stick 1600 may include a portion configured to glow when the stick is exposed to light. For example, the smooth portion may run the length of the stick. Optionally the smooth portion may include grooves and/or protrusions. For example, stick 1900 includes a lengthwise groove 1913 along the length of the stick 1900 along the center of the smooth wide side face 1912. For example, stick 1900 includes lengthwise protrusions 1918 along the length of the stick 1900 along the edges of the wide side face 1912 of the stick. For example, projections may enhance the light transmitting and/or emission of the stick 1900. Additionally or alternatively, projections and/or recessions may be located in other parts of a face of the stick 1900 and/or be oriented in any direction. For example, the smooth portion may occupy between 80 to 100% of the face and/or between 50 to 80% and/or between 20 to 50% of the face.

In some embodiments, the stick 1900 includes a side face 1916 that is thinner than the front face 1912. For example, the thickness of the stick 1900 (e.g., the width of the side face 1916) may be between 50 to 80% the width of the stick 1900 (e.g., the width of the front face 1912) and/or thickness of the stick 1900 may be between 20 to 50% the width of the stick 1900 and/or thickness of the stick 1900 may be between 80 to 100% the width of the stick 1900. Optionally, the side face 1916 is configured to glow when light is applied to the stick 1900. For example, the side face 1916 may be smooth. Optionally, an end 1914 of the stick 1900 may be rounded and/or squared and/or may be smooth and/or may include one or more connectors (e.g., teeth).

Optionally one or more tracks of connectors 1910 may project from and/or be recessed into opposite faces of a component (e.g., stick 1900). Alternatively or additionally, tracks may project and/or be recessed one face (e.g., one side 1916) while the opposing face may be smooth and/or include other connectors. In some embodiments, a track may be linear. Alternatively or additionally, a track may circular and/or curved. A track may have an open form (e.g., a line and/or a semicircle) and/or closed form (e.g., a circle and/or an oval etc. (e.g., surrounding the entire periphery of the stick 1900)).

FIG. 20A is an illustration of multiuse stick 1900 and a matching connector 2020 in accordance with an embodiment of the current invention.

FIG. 20B is a close-up illustration of a matching component 2000 configured to connect to stick 1900 in accordance with an embodiment of the current invention. For example, a matching component 2000 may include a ring. Optionally the ring may include a slit 2022 and/or a thinned section 2026 and/or a thickened section for example, to enhance the flexibility of the ring. For example, a partially closed cavity (e.g., the hollow center of ring) and/or a fully closed cavity may link to another component (e.g., stick 1900) by surrounding a portion of the component. A matching component 2000 may include connectors that link to connectors on another stick 1900. For example, component 2000 includes inward protrusions the fit into and/or slide along longitudinal groove 1913 of stick 1900. For example, component 2000 includes a recession 2028 into which fits (and/or which slides along) lengthwise protrusions 1918 of stick 1900. For example, matching component 2000 includes triangular teeth 2010 that link to connectors 1910 (e.g., triangular toothed track) of stick 1900. For example, due to the flexibility of the ring of component 2000 and/or the angles of teeth 2010, the ring may perform the function of a ratchet holding the ring in place along the stick 1900. Alternatively or additionally, a matching component may be held by friction (e.g., without teeth 2010) and/or grasping (e.g., without matching protrusions 2027 and/or recessions 2028). In some embodiments,

In some embodiments, a connecting component 2000 may interface between two other components. Alternatively or additionally, a decorative component may have a build in connection. For example, the hole in the arms of component 114 may be rotated at 90 degrees and be shaped and sized like the ring of component 2000 to link to stick 1900. In some embodiments, a matching component may be transparent, translucent and/or opaque. Optionally, a matching component may block light, transmit light and/or include a light source.

FIG. 20C is a close-up illustration of a multiuse stick 1900 with a toothed track projecting from a thin side thereof and a matching component 2000 in accordance with an embodiment of the current invention.

These embodiments are provided by way of example and are in no means intended to limit the scope of the invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

### General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein the term “about” refers to +10%

The terms “comprises”, “comprising”, “includes”, “including”, “having” and their conjugates mean “including but not limited to”.

The term “consisting of” means “including and limited to”.

The term “consisting essentially of” means that the composition, method, or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

As used herein, the term “plurality” relates to 2, 3, 4, 5, 6, 7, 8, 9, 10, 11, 12, 13, 14, 15, 20, 25, 30, 40, 50, 100, 500, 1,000, etc. or any sub-range therebetween.

As used herein, the terms “popsicle”, “ice-lolly”, “freezer pop”, “paleta”, and “ice pops” are used interchangeably, and relate to a frozen treat on a stick, typically made from flavored water, juice, or frozen dessert.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may additionally be provided in combination in a single embodiment. Conversely, various features of the invention, which are, for brevity, described in the context of a single embodiment, may additionally be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent, or patent application was specifically and individually indicated to be incorporated herein by reference. In addition, citation, or identification of any reference in this application shall not be construed as an admission that such reference is available as prior art to the present invention. To the extent that section headings are used, they should not be construed as necessarily limiting.

What is claimed is:

1. A method of use of a reusable popsicle stick, the method comprising:
preparing a popsicle including a reusable popsicle stick including at least one of a connector and a built-in light source; and
reusing the popsicle stick including at least one of
connecting the connector to another popsicle stick,
connecting the connector to an external light source,
connecting the connector the connector to decoration,
wearing the reusable popsicle stick and
activating the built-in light source.

2. The method according to claim 1, wherein the reusable popsicle stick is reused as a party favor.

3. The method according to claim 1, wherein the reusable popsicle stick is reused as a light source.

4. The method according to claim 1, wherein the reusable popsicle stick is reused as a toy, or part thereof.

5. The method according to claim 1, wherein the reusable popsicle stick includes multiple connectors configured for reuse of the reusable popsicle stick.

6. The method according to claim 5, wherein the reusable popsicle stick includes the connector and the connector include at least one of a hole, a slit, a groove, a track, a tooth, a protrusion, a ratchet track and a flexible connector.

7. The method according to claim 6, wherein the connectors are configured to facilitate interlinking between two or more reusable popsicle sticks.

8. A reusable popsicle stick comprising:
a reusable light guide stick; and
a light emitting unit.

9. The stick according to claim 8, wherein the reusable light guide stick includes the light emitting unit internally.

10. The stick according to claim 8, wherein the reusable light guide stick is connected to the light emitting unit externally.

11. The stick according to claim 8, wherein the light guide stick is composed of a light conducting material.

12. The stick according to claim 11, wherein the light conducting material is selected from the group comprising acrylic (polymethylmethacrylate), butyrate (cellulose acetate butyrate), polyvinyl chloride, polycarbonate, polyethylene terephthalate, glycol modified polyethylene terephthalate, polytetrafluoroethylene, polystyrene, polypropylene, polyamide, or a combination thereof.

13. The stick according to claim 8, wherein the stick is colorless.

14. The stick according to claim 8, wherein the stick is colored.

15. The stick according to claim 8, wherein the stick includes multiple connectors configured for reuse of the reusable popsicle stick.

16. The stick according to claim 15, wherein the connectors are holes, slits, protrusions, or flexible connectors.

17. The stick according to claim 16, wherein the connectors are configured to facilitate interlinking between two or more reusable popsicle sticks.

18. The stick according to claim 8, wherein the light emitting unit comprises one or more LEDs, a controller and a battery, for empowering the controller and the LEDS via the controller.

19. The stick according to claim 18, wherein the light emitting unit further comprises a user interface.

20. The stick according to claim 8, wherein the light emitting unit is configured to make the popsicle and/or the stick glow.
